(19) United States
(12) Patent Application Publication
(10) Pub. No.: US 2026/0064972 A1
(43) Pub. Date: Mar. 5, 2026

(54) Language-Based Attention Mechanisms for Machine-Learned Models

(71) Applicant: Google LLC, Mountain View, CA (US)

(72) Inventors: Ramin Mehran, Kirkland, WA (US); Nilpa Jha, Sammamish, WA (US)

(21) Appl. No.: 18/816,835

(22) Filed: Aug. 27, 2024

(51) Int. Cl. G06F 40/30; G06F 40/289; G06N 20/00; G06V 20/40

(52) U.S. Cl. CPC G06F 40/30; G06F 40/289; G06N 20/00; G06V 20/41

(57) ABSTRACT

For each portion of a content item, the portion of the content item can be processed with a machine-learned Large Foundational Model (LFM) to obtain an attentional value output comprising a summarization of the portion. The attentional value output can be processed with the machine-learned LFM to obtain an attentional query output descriptive of thematic elements associated with the portion, and an attentional key output comprising key words and/or phrases from the portion. An attentional weight can be determined for each portion based on a semantic similarity between the attentional query output and the attentional key output for each portion. A subset of portions of the content item can be selected based on the attentional weight determined for the subset. A task output can be generated based on the attentional value output obtained for each of the subset of portions.

### FIELD

The present disclosure relates generally to attention mechanisms for machine-learned models. More particularly, the present disclosure relates to determining language-based attention to enable attention mechanisms for long-form content items.

### BACKGROUND

A computer can receive input(s). The computer can execute instructions to process the input(s) to generate output(s) using a parameterized model. The computer can obtain feedback on its performance in generating the outputs with the model. For example, the computer can generate the feedback by performing an evaluation of the output. For another example, the computer can receive feedback from an external source. The computer can update parameters of the model based on the feedback to improve its performance. In this manner, the computer can iteratively “learn” to generate the desired outputs. The resulting model is often referred to as a machine-learned model.

Generally, machine-learned models can be trained to process an input to generate an output. In some fields of machine learning, such as Natural Language Processing (NLP), the maximum size of an input to a model is referred to as a “context window.” A context window refers to the “size” or quantity of data that can be processed by the model at any given time. For example, in some machine-learned models such as Large Language Models (LLMs), the context window size dictates how many words or tokens the model can use to understand and generate coherent and contextually appropriate responses. Larger context windows allow the model to consider more information simultaneously, leading to better comprehension of complex inputs and improved performance in tasks like text generation, translation, and summarization.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method includes, for each portion of a plurality of portions of a content item, processing, by a computing system comprising one or more processing devices, the portion of the content item with a machine-learned Large Foundational Model (LFM) to obtain an attentional value output comprising a summarization of the portion of the content item. The method includes, for each portion of a plurality of portions of a content item, processing, by the computing system, the attentional value output with the machine-learned LFM to obtain an attentional query output descriptive of thematic elements associated with the portion of the content item. The method includes, for each portion of a plurality of portions of a content item, processing, by the computing system, the attentional value output with the machine-learned LFM to obtain an attentional key output comprising key words and/or phrases from the portion of the content item. The method includes determining, by the computing system, an attentional weight for each portion of the plurality of portions of the content item based on a semantic similarity between the attentional query output and the attentional key output for each of the plurality of portions. The method includes selecting, by the computing system, a subset of portions of the plurality of portions of the content item based on the attentional weight determined for each of the subset of portions. The method includes generating, by the computing system, a task output based on the attentional value output obtained for each of the subset of portions.

Another example aspect of the present disclosure is directed to a computing system. The computing system can include one or more processor devices and one or more non-transitory computer-readable media that store instructions that, when executed by the one or more processors, cause the computing system to perform operations. The operations include, for each portion of a plurality of portions of a content item, processing the portion of the content item with a machine-learned Large Foundational Model (LFM) to obtain an attentional value output comprising a summarization of the portion of the content item. The operations include, for each portion of a plurality of portions of a content item, processing the attentional value output with the machine-learned LFM to obtain an attentional query output descriptive of thematic elements associated with the portion of the content item. The operations include, for each portion of a plurality of portions of a content item, processing the attentional value output with the machine-learned LFM to obtain an attentional key output comprising key words and/or phrases from the portion of the content item. The operations include determining an attentional weight for each portion of the plurality of portions of the content item based on a semantic similarity between the attentional query output and the attentional key output for each of the plurality of portions. The operations include selecting a subset of portions of the plurality of portions of the content item based on the attentional weight determined for each of the subset of portions. The operations include generating a task output based on the attentional value output obtained for each of the subset of portions.

Another example aspect of the present disclosure is directed to one or more non-transitory computer-readable media that store instructions that, when executed by one or more processor devices, cause the one or more processor devices to perform operations. The operations include, for each portion of a plurality of portions of a content item, processing the portion of the content item with a machine-learned Large Foundational Model (LFM) to obtain an attentional value output comprising a summarization of the portion of the content item. The operations include, for each portion of a plurality of portions of a content item, processing the attentional value output with the machine-learned LFM to obtain an attentional query output descriptive of thematic elements associated with the portion of the content item. The operations include, for each portion of a plurality of portions of a content item, processing the attentional value output with the machine-learned LFM to obtain an attentional key output comprising key words and/or phrases from the portion of the content item. The operations include determining an attentional weight for each portion of the plurality of portions of the content item based on a semantic similarity between the attentional query output and the attentional key output for each of the plurality of portions. The operations include selecting a subset of portions of the plurality of portions of the content item based on the attentional weight determined for each of the subset of portions. The operations include generating a task output based on the attentional value output obtained for each of the subset of portions

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIGS. 1A and 1B are overview block diagrams for generating attentional values, queries, and keys using language-based attention mechanisms for machine-learned models according to some implementations of the present disclosure.

FIG. 2A is a block diagram for determining attentional weights for portions of a content item based on the attentional values, queries, and keys of FIGS. 1A and 1B according to some implementations of the present disclosure.

FIG. 2B is a block diagram for generating attentional weight information based on a semantic similarity between attentional key and query outputs according to some implementations of the present disclosure.

FIG. 3 is a data flow diagram for a hierarchical processing structure that implements a parallelized language-based attention mechanism for machine-learned models according to some implementations of the present disclosure.

FIG. 4 is a block diagram of a machine-learned Large Foundational Model (LFM) with multiple attention heads according to some implementations of the present disclosure.

FIG. 5 is a flow diagram of an example method for processing inputs with a language-based attention mechanism according to some implementations of the present disclosure.

FIG. 6A depicts a block diagram of an example computing system that performs generative tasks using language-based attention mechanisms according to some implementations of the present disclosure.

FIG. 6B depicts a block diagram of an example computing device that performs model training according to example embodiments of the present disclosure.

FIG. 6C depicts a block diagram of an example computing device that performs generative tasks using language-based attention mechanisms according to some implementations of the present disclosure.

Reference numerals that are repeated across plural figures are intended to identify the same features in various implementations.

### DETAILED DESCRIPTION

### Overview

Generally, the present disclosure is directed to determining language-based attention to enable attention mechanisms for long-form content items. More specifically, the addition of attention mechanisms to machine-learned models has substantially improved the performance of such models in recent years. As such, attention mechanisms are critical in many advanced machine learning models, such as those in the fields of Natural Language Processing (NLP) and computer vision. Attention mechanisms enable models to identify the relevance of discrete portions of an input, rather than treating all input data uniformly. For example, in NLP tasks, attention mechanisms allow models to weigh the importance of different words in a sentence when making predictions or generating text. This determination of relevancy results in more accurate and contextually appropriate outputs, as the model can consider dependencies between words that may be far apart in the input sequence.

In some fields of machine learning, such as NLP or computer vision, the maximum size of an input to a model is referred to as a “context window.” A context window refers to the “size” or quantity of data that can be processed by the model at any given time. For example, in some machine-learned models such as Large Language Models (LLMs), the context window size dictates how many words or tokens the model can use to understand and generate coherent and contextually appropriate responses. Larger context windows allow the model to consider more information simultaneously, leading to better comprehension of complex inputs and improved performance in tasks like text generation, translation, and summarization.

Conventional attention mechanisms generally calculate an attentional query, an attentional key, and an attentional value for a given an input token sequence. A typical attentional query (e.g., a vector representation, etc.) can represent the current input token for which a machine-learned model is seeking relevant information from other tokens. A typical attentional key can be, or include, representations of each input token that enable the model to determine the relevance of other input tokens to the input token being evaluated by the attentional query. An attentional value is generally a representation (e.g., vector representation, etc.) of the actual information or content associated with each input token. Once the model has identified relevant input tokens using the attentional query and key, the values associated with those tokens can be processed to generate a final output.

However, context windows can limit the effectiveness of the attention mechanism described above. For example, assume that the first portion of a textual content item (e.g., an article, book, etc.) introduces a key concept, and a second portion of the textual content item provides a discussion of the key concept. If the context window for a machine-learned model is sufficiently large to process both the first and second portions of the content item, the attention mechanism of the model can enable the model to accurately analyze the second portion based on the context of the first portion. Conversely, if the context window is only large enough to process a single portion of the textual content item, the performance of the attention mechanism can be substantially degraded when analyzing the second portion of the content item due to lacking the context provided by the first portion of the content item. As such, a technique to efficiently determine attentional weights over multiple context windows is greatly desired.

Accordingly, implementations described herein propose language-based attention mechanisms for machine-learned models. By representing aspects of an attention mechanism via language, attention calculations can be efficiently parallelized while retaining the benefits of attention determined across context windows. More specifically, a content item can be obtained that includes a plurality of portions (e.g., portions of a song, movie, recording, video clip, image, text document, multimedia document, etc.). Each portion of the content item can be processed with a machine-learned Large Foundational Model (LFM). As described herein, a LFM generally refers to a machine-learned model with a substantial quantity of parameters that enable the model to perform multiple types of tasks. Examples of LFMs include Large Language Models (LLMs) trained to perform multiple language tasks, large vision models trained to perform multiple vision tasks, large multimodal models trained to process multiple types of inputs to generate multiple types of outputs, etc.

An attentional value output can be obtained by processing the portions of the content item with the machine-learned LFM. Unlike conventional attentional values, which are generally vector representations, the attentional value output can include a summarization of the portion of the content item. For example, if the portion of the content item was a chapter in a book, the attentional value output can summarize the chapter of the book. For another example, if the portion of the content item was a region of an image, the attentional value output can summarize what is depicted within that region of the image. By summarizing the entirety of the portion of the content item, the attentional value output can capture the same (or a similar) type of information typically included in a conventional attention value (e.g., a vector-based representation).

The attentional value output can then be processed with the machine-learned LFM alongside an attentional query prompt to obtain an attentional query output. The attentional query output can identify thematic elements associated with the portion of the content item. These thematic elements can encode the same (or a similar) type of information as a conventional attention query. The attentional value output can also be processed with the machine-learned LFM alongside an attentional key prompt to obtain an attentional key output. The attentional key output can include key words and/or phrases from the portion of the content item. The thematic elements can encode the same (or a similar) type of information as a conventional attention key.

This process can be repeated for each portion of the content item. An attentional weight can be determined for each portion of the content item based on a semantic similarity between the attentional query for the content item and the attentional key for each other portion of the content item. The attentional weights can then be used to select some (or all) of the portions of the content item to generate a task output (e.g., the task initially requested of the model). In such fashion, machine-learned models can be leveraged to implement attention mechanisms via natural language outputs, thus enabling content items that are larger than the context window of a model to be processed via parallelization while retaining the benefits provided by attention mechanisms.

Aspects of the present disclosure provide a number of technical effects and benefits. As one example technical effect and benefit, the context window size in certain models, such as Large Language Models (LLMs), can substantially limit the model’s capacity to understand context when a content item is larger than the context window size. In turn, this limited capacity can substantially degrade model performance, especially for tasks that depend on a contextual understanding of the entire content item (e.g., summarization). Some conventional approaches have attempted to create node-based model architectures to implement a “divide-and-conquer” technique to mitigate this problem. However, such approaches require substantial resources to implement due to the substantial cost associated with creating and training new models. Furthermore, such architecture modifications can decrease performance of the model in some instances.

Accordingly, implementations described herein propose language-based attention mechanisms for machine-learned models. More specifically, by encoding attention values, keys, and queries as natural language outputs, implementations described herein enable the use of LFM instances as computation units. In turn, by utilizing the LFM instances as computation units, this approach effectively obviates the limitations imposed by model context windows, as any number of additional model instances can be instantiated to handle larger content items (and vice-versa). Furthermore, this approach can utilize existing models without requiring major overhauls to the model architecture and/or expensive training processes. In this manner, implementations described herein eliminate performance losses caused by insufficient model context windows, thus substantially improving model performance without requiring the expenditure of resources to train and/or modify existing models.

With reference now to the Figures, example embodiments of the present disclosure will be discussed in further detail.

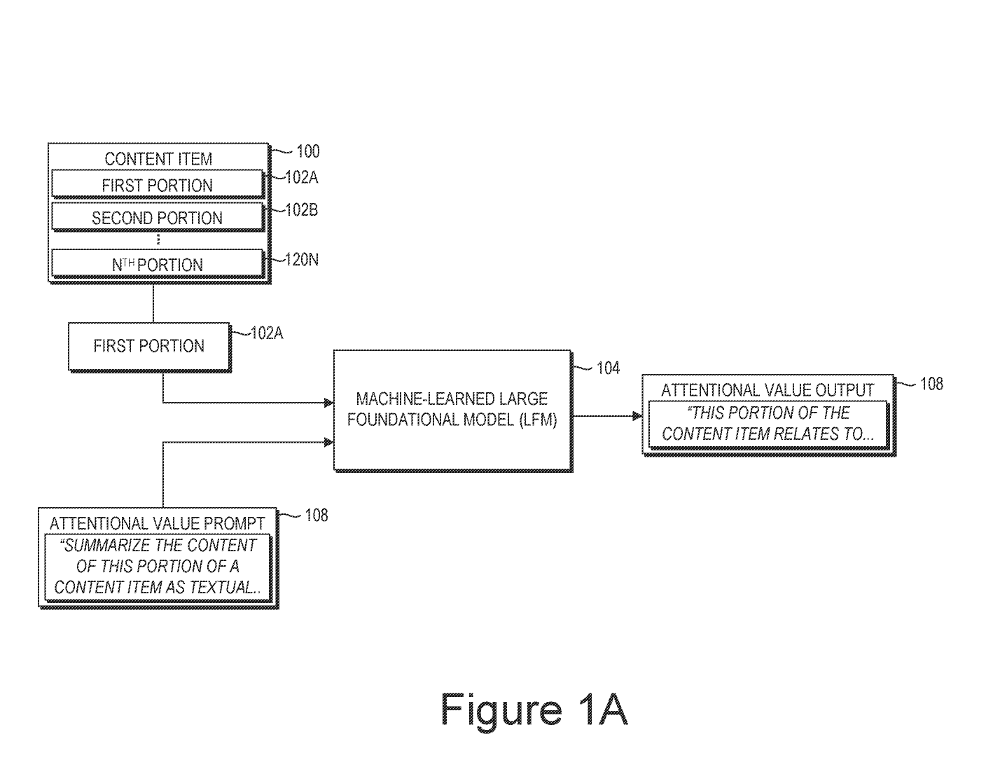

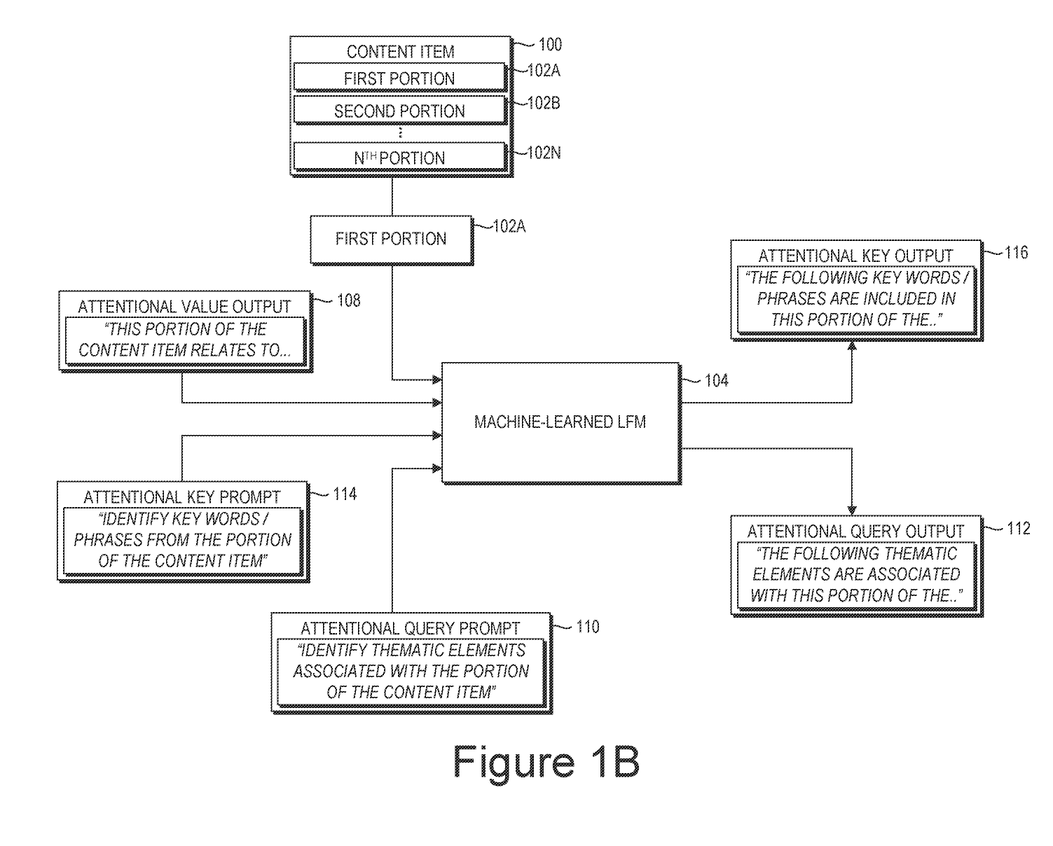

FIGS. 1A and 1B are overview block diagrams for generating attentional values, queries, and keys using language-based attention mechanisms for machine-learned models according to some implementations of the present disclosure. More specifically, turning to FIG. 1A, a content item 100 can be obtained. As described herein, “content” can refer to any type or manner of content, such as audio data, video data, textual content, multimedia data (e.g., audiovisual data, etc.), Augmented Reality (AR) / Virtual Reality (VR) data, etc. A “content item” can refer to a discrete portion of content, such as a document, a portion of a document (e.g., a chapter in a book, a section of a research paper, a web page of a website, etc.), a video, a song, a book, etc.

The content item 100 can include, or can be segmented into, a plurality of portions. In some implementations, the content item 100 can be segmented into portions 102A – 102N (generally, portions 102) based on some existing organization or division of the content item. For example, if the content item 100 is a book, the content item 100 may be segmented or divided on a per-chapter basis. Alternatively, in some implementations, the content item 100 can be divided based on the size of a context window for a model being used to process the content item 100.

More specifically, a machine-learned Large Foundational Model (LFM) 104 can be obtained. As described herein, a machine-learned LFM can refer to any type, manner, or collection of machine-learned model(s) that include a quantity of parameters sufficient to enable the performance of multiple generative tasks, such as summarization tasks. Examples of machine-learned LFMs can include LLMs, large visual models, large multimodal models (e.g., LFMs that can process audio and/or video inputs), etc. As such, the machine-learned LFM 104 can process any type or manner of content (e.g., audio data, video data, application-specific data, etc.) and can produce any type or manner of output (e.g., image data, audio data, etc.).

A first portion 102A of the content item 100 can be processed with the machine-learned LFM 104 alongside an attentional value prompt 106. The attentional value prompt 106 can be a prompt that includes instructions for the machine-learned LFM 104. Specifically, the attentional value prompt 106 can instruct the machine-learned LFM 104 to summarize the content of the first portion 102A of the content item 100. In response, the machine-learned LFM 104 can generate an attentional value output 108. The attentional value output 108 can include a summarization of the first portion 102A of the content item 100. This summarization included in the attentional value output 108 can encode the same information as a “conventional” attentional value typically determined using conventional attention mechanisms. The attentional value output 108 can include any type or manner of data, such as audio data, video data, textual content, etc. For example, if the first portion 102A of the content item 100 is textual content comprising the first chapter in a book, the attentional value output 108 can be a textual summarization of the first chapter in the book.

In some implementations, the attentional value output 108 can include a different type of information than the information included in the first portion 102A of the content item 100. For example, assume that the content item 100 is a movie, and the first portion 102A is audiovisual data that comprises the first segment of the movie. Although the first portion 102A includes audiovisual data, the attentional value output 108 can be textual content that describes a summary of what is depicted by the first portion 102A. For example, if the audiovisual data includes a spoken utterance from a human actor, the spoken utterance may be referenced or described by the attentional value output 108. Alternatively, the attentional value output 108 may be one or more audiovisual clips extracted from the first portion 102A that serve to summarize what is depicted by the first portion 102A.

Turning to FIG. 1B, after (or concurrently with) generating the attentional value output 108, the machine-learned LFM 104 can be utilized to generate additional attentional outputs. More specifically, in some implementations, the attentional value output 108 can be processed alongside an attentional query prompt 110 to obtain an attentional query output 112. The attentional query prompt 110 can instruct the machine-learned LFM 104 to identify thematic elements associated with the portion of the content item from the portion of the content item. The attentional query output 112 can describe the thematic elements associated with the portion of the content item. This description of the thematic elements can encode the same manner of information encoded by “conventional” attentional query values. To follow the previous example, if the first portion 102A is the first segment of a movie, the attentional query output 112 can include textual content describing the thematic elements associated with what is depicted in the first portion 102A.

Similarly, the attentional value output 108 can be processed alongside an attentional key prompt 114 to obtain an attentional key output 116. The attentional key prompt 114 can instruct the machine-learned LFM 104 to select key words and/or phrases included in the first portion 102A of the content item 100. The attentional key output 116 can describe the key words and/or phrases included in the first portion 102A of the content item 100. This description of the key words and/or phrases can encode the same manner of information encoded by “conventional” attentional key values. To follow the previous example, if the first portion 102A is the first segment of a movie, the attentional query output 112 can include textual content describing the key concepts and/or phrases included in or otherwise depicted by the first portion 102A.

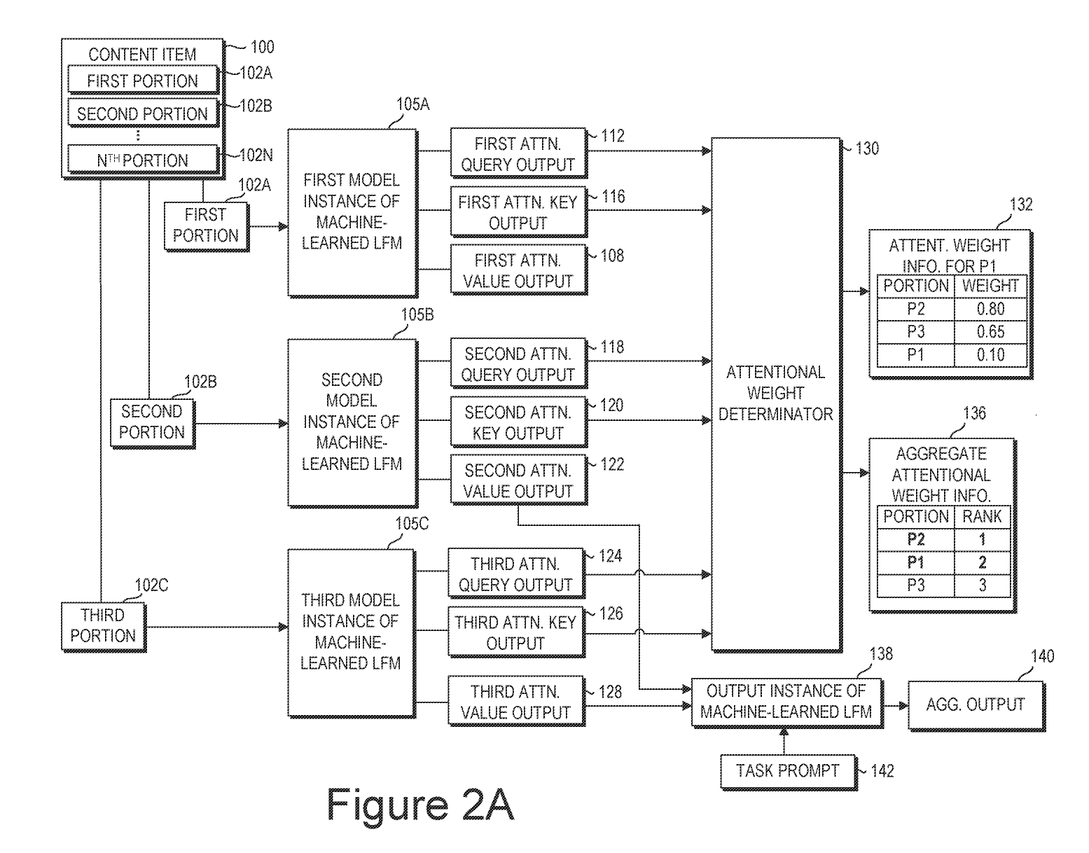

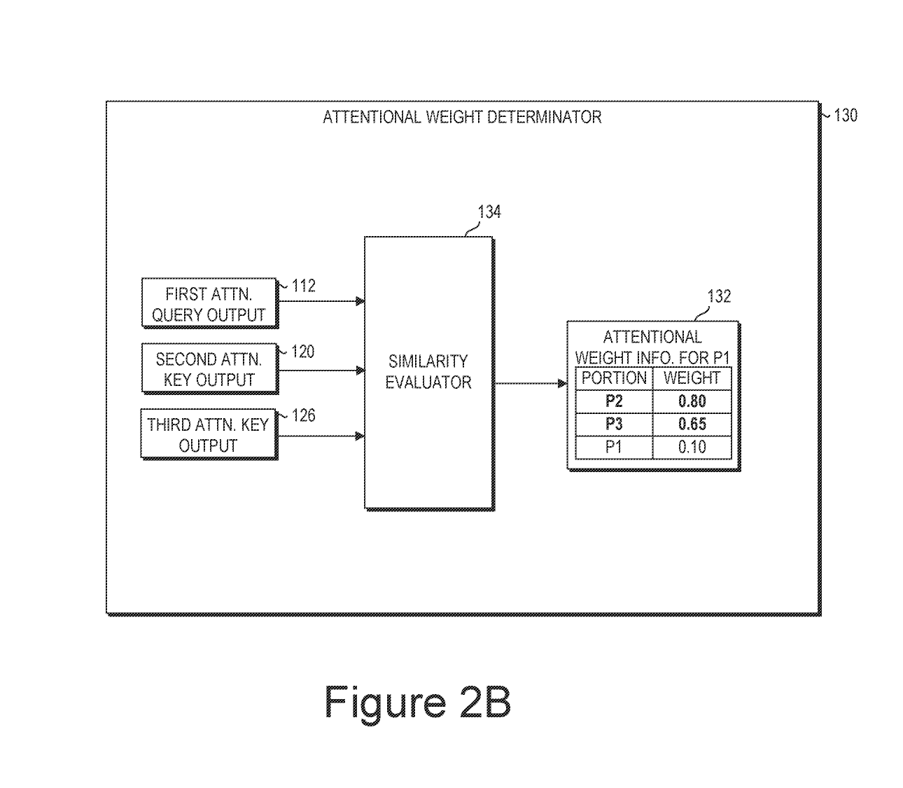

FIG. 2A is a block diagram for determining attentional weights for portions of a content item based on the attentional values, queries, and keys of FIGS. 1A and 1B according to some implementations of the present disclosure. FIG. 2A will be discussed in conjunction with FIGS. 1A and 1B. Turning to FIG. 2A, as described with regards to FIGS. 1A and 1B, the content item 100 can include portions 102, and the portions 102 can be processed with the machine-learned LFM 104 to generate attentional values, keys, and queries. This process can be repeated to generate attentional values for each of the other portions of the content item 100. In particular, the process can be performed concurrently to parallelize calculation of the attentional values by leveraging multiple instances of the machine-learned LFM 104.

To do so, a plurality of model instances 105A – 105C (generally, model instances 105) can be instantiated for processing the portions of the content item 100. As the portions 102 of the content item 100 can be determined so that the size of each portion is smaller than the context window of the machine-learned LFM 104, each of the model instances 105 can fully process a portion of the content item 100. In some implementations, the quantity of instantiated model instances can be equal to the quantity of portions of the content item 100 (e.g., ten instances for ten portions, etc.). Alternatively, in some implementations, the quantity of the model instances 105 can be less than the quantity of portions of the content item 100. For example, assume that a fourth portion (not illustrated) of the content item 100 was to be processed with one of the model instances 105. In this scenario, the fourth portion can be provided to the first model instance of the model instances 105 that has completed processing of a preceding portion of the content item 100.

To follow the depicted example, the first model instance 105A can process the first portion 102A to obtain the attentional value output 108 (now referred to as first attentional value output 108), the attentional query output 112 (now referred to as first attentional query output 112), and the attentional key output 116 (now referred to as first attentional key output 116). A second model instance 105B can process a second portion 102B of the content item 100 to obtain a second attentional query output 118, a second attentional key output 120, and a second attentional value output 122. A third model instance 105C can process a third portion 102C of the content item 100 to obtain a third attentional query output 124, a third attentional key output 126, and a third attentional value output 128.

The model instances 105 can generate the attentional value outputs 108, 122, and 128 as described with regards to FIGS. 1A and 1B. In particular, the second model instance 105B and the third model instance 105C can both be provided the same attentional query prompt 110 to generate the second attentional query output 118 and the third attentional query output 124, respectively. For example, the second model instance 105B can process the second portion 102B of the content item 100 and the attentional query prompt 110 to generate a summarization of the second portion 102B.

An attentional weight determinator 130 can be utilized to generate attentional weight information. In particular, the attentional weight determinator 130 can generate attentional weight information 132 for the first portion 102A. The attentional weight information 132 can include an attentional weight for the other portions of the content item 100. These attentional weights can indicate a degree of similarity between the first attentional query output 112 and the attentional key values obtained for other portions of the content item 100.

For a specific example, turning to FIG. 2B, FIG. 2B is a block diagram for generating attentional weight information based on a semantic similarity between attentional key and query outputs according to some implementations of the present disclosure. FIG. 2B will be discussed in conjunction with FIGS. 1A, 1B, and 2. In particular, the attentional weight determinator 130 can include a similarity evaluator 134. The similarity evaluator 134 can be a machine-learned model (or portion thereof), or the like, that can evaluate a similarity between inputs. The attentional weight information 132 can be generated based on the similarity between the first attentional query output 112 and the key outputs for other portions of the content item 100.

To follow the depicted example, the similarity evaluator 134 can determine an attentional weight of 0.8 for the second portion 102B based on a similarity between the second attention key output 120 and the first attention query output 112. As described previously, the first attentional query output 112 can describe thematic elements associated with the first portion 102A, and the second attentional key output 120 can include key words and/or phrases from the second portion 102B. If the similarity evaluator 134 determines a strong similarity between the thematic elements of the first portion 102A and the key words / phrases of the second portion 102B, it is likely that the first portion 102A is relevant to the second portion 102B. As such, the attentional weight determined based on this similarity can be relatively high (e.g., 0.8). Conversely, by determining an attentional weight of 0.65 for the third portion 102C, it can be inferred that the third portion 102C is less similar (and thus less relevant) to the first portion 102A. In some implementations, an attentional weight can also be determined for the first portion 102A to itself based on a similarity between the first attention query output 112 and the first attention key output 116.

Returning to FIG. 2A, the attentional weight information 132 can be generated for the first portion 102A as described previously. Similarly, attentional weight information can also be generated for the second portion 102B and the third portion 102C (not illustrated). In some implementations, aggregate attentional weight information 136 can be generated based on the attentional weight information 132 generated for the first portion 102A and other portions of the content item 100. The aggregate attentional weight information 136 can rank the portions 102 of the content item 100 based on the attentional weights calculated the portions 102 of the content item 100. For example, the attentional weight information 132 assigns a weight of 0.8 to the second portion 102B. If attentional weight information for the third portion 102C assigns a weight of 0.4 to the second portion 102B, the aggregate attentional weight information 136 can include an average weight of 0.6 for the second portion 102B, and can rank the second portion 102B based on the average weight.

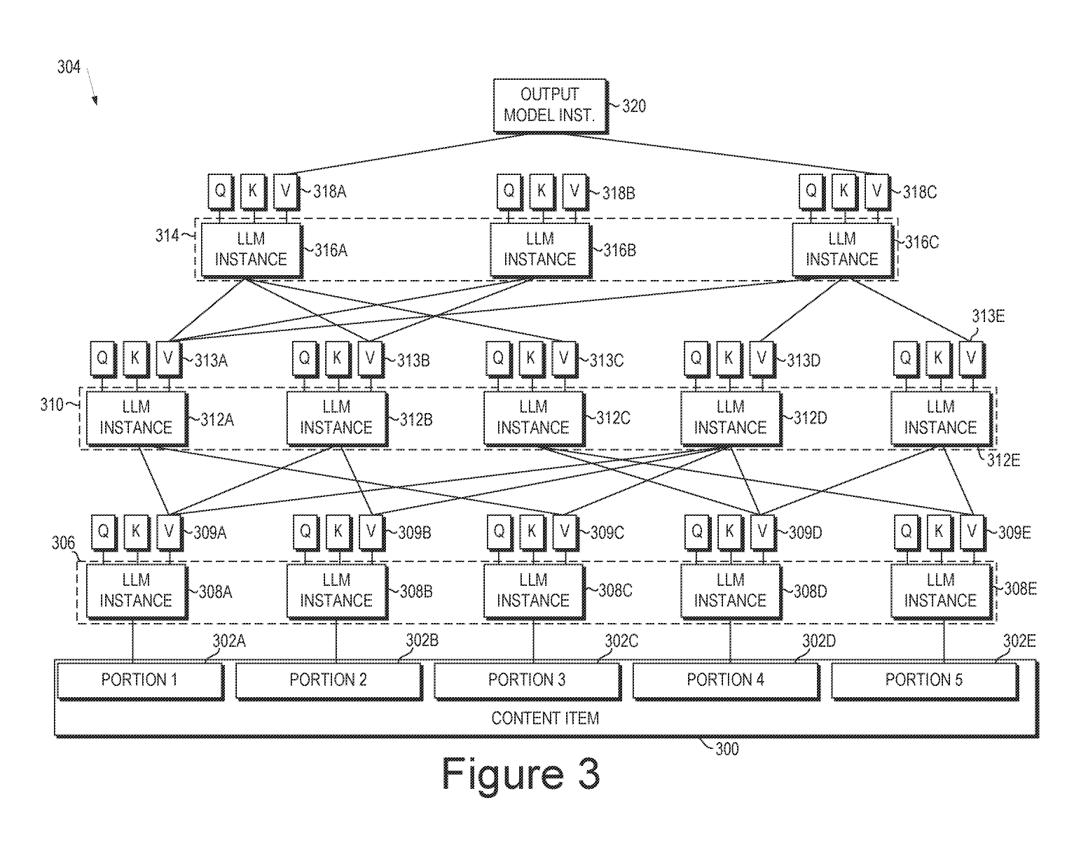

In some implementations, an output instance 138 of the machine-learned LFM 104 can be utilized to generate an output 140. The output instance 138 can be an instance of the machine-learned LFM 104 as described with regards to the model instances 105. The output instance 138 can process attentional values generated by some (or all) of the model instances 105 to generate the output 140. In some implementations, the machine-learned LFM instances 105 can form one model instance layer of a hierarchical processing structure that includes a sequence of model instance layers. For example, assume that the model instances 105 form one layer of a hierarchical processing structure. As the model instances 105 feed to the output instance 138, other layers within the hierarchical processing structure can precede the layer formed by the model instances 105. These preceding layers can feed attentional values to the model instances 105 that are derived from the portions 102 of the content item 100, rather than directly processing the portions 102 as illustrated. Alternatively, the model instances 105 may form a single layer of a single-layer processing structure that generates the output 140. Hierarchical processing structures will be discussed in greater detail with regards to FIG. 3.

Specifically, in some implementations, a subset of the attentional values generated by the model instances 105 can be selected based on the aggregate attentional weight information 136. For example, assume that a selection threshold is set of an average weight of 0.3. Further assume that the average weights for the first attentional value output 108, second attentional value output 122, and the third attentional value output 128 are 0.7, 0.9, and 0.2 respectively. Because the average attentional weights for the first portion 102A and the second portion 102B are higher than the selection threshold, the first attentional value output 108 and the second attentional value output 122 can be selected as inputs to the output instance 138. The output instance 138 can process the first attentional value output 108, the second attentional value output 122, and the task prompt 142 to generate the output 140.

The output 140 can be any type or manner of output requested of the machine-learned LFM 104. In some implementations, the output 140 can be a task output corresponding to a task prompt 142. For example, the task prompt 142 can include a request to identify the main character of the content item 100. The output instance 138 can process the task prompt 142, the first attentional value output 108, and the second attentional value output 122 to generate the output 140, which can identify the main character (e.g., textual content describing the character, an image depicting the character, an audio and/or video clip featuring the character, a three-dimensional representation of the character, etc.). Because the first attentional value output 108 and the second attentional value output 122 have been selected via the aggregate attentional weight information 136, it is most likely that either (or both) portions of the content item 100 include information that identifies the main character. In such fashion, implementations described herein can enable language-based attention mechanisms for machine-learned models.

Additionally, or alternatively, in some implementations, the output 140 can be an aggregate output that aggregates the selected attentional value outputs from the model instances 105. In some implementations, the aggregate output can serve as a subsequent input from which a task output can be derived. To follow the previous example, the output 140 can aggregate the information included in the first attentional value output 108 and the second attentional value output 122. The output 140 can then be processed with a second output instance of the machine-learned LFM 104, a different machine-learned model, a layer of a machine-learned model (e.g., an output layer), etc.

FIG. 3 is a data flow diagram for a hierarchical processing structure that implements a parallelized language-based attention mechanism for machine-learned models according to some implementations of the present disclosure. More specifically, a content item 300 can be obtained as described with regards to the content item 100 of FIGS. 1A and 1B. The content item 300 can include a plurality of portions 302A – 302E. The content item 300 can be processed using a hierarchical processing structure 304. The hierarchical processing structure 304 is illustrated as including a plurality of LLMs. However, it should be noted that any type of LFM can be utilized within the hierarchical processing structure 308.

The hierarchical processing structure 304 can include a first model instance layer 306. The first model instance layer 306 can include first layer model instances 308A – 308E (generally, first layer model instances 308). The hierarchical processing structure 304 can include a second model instance layer 310. The second model instance layer 310 can include second layer model instances 312A – 312E (generally, second layer model instances 312). The hierarchical processing structure 304 can include a third model instance layer 314. The third model instance layer 314 can include third layer model instances 316A – 316E (generally, third layer model instances 316).

In some implementations, the first model instance layer 306 can include a quantity of model instances equal to the quantity of portions 302. Alternatively, in some implementations, the first model instance layer 306 can include a quantity of model instances fewer than the quantity of portions 302. The first layer model instances 308 can process the portions 302 to generate first layer attentional outputs 309A – 309E (generally, first layer attentional outputs 309). To follow the illustrated example, the first layer model instance 308A can process the portion 302A to obtain first layer attentional outputs 309A, the first layer model instance 308B can process the portion 302B to obtain first layer attentional outputs 309B, etc. Each of the first layer attentional outputs 309 can include an attentional query output, key output, and value output as described with regards to FIGS. 1-2B.

Once the first layer attentional outputs 309 are generated, the first layer attentional outputs 309 can be processed by the second layer model instances 312 of the second model instance layer 310. Specifically, each of the second layer model instances 312 can process one or more attentional value outputs from the first layer attentional outputs 309. The particular attentional value output(s) processed with each of the second layer model instances 312 can be determined based on the attentional weights determined using the attentional key and query outputs of the first layer attentional outputs 309.

To follow the depicted example, attentional weights can be determined for the portion 302A based on a semantic similarity between the attentional query value of the first layer attentional outputs 309A and the attentional key value of the first layer attentional outputs 309B – 309E. Based on the attentional weights, a subset of the portions 302 most similar (or relevant) to the portion 302A can be identified. For example, if the attentional query output of the first layer attentional outputs 309A is most similar to the attentional key output of the first layer attentional outputs 309C (or that similarity is above a threshold similarity), the attentional values from the first layer attentional outputs 309A and 309C can be processed together by the second layer model instance 312A. For another example, if the attentional query output of the first layer attentional outputs 309D is most similar to the attentional key outputs of the first layer attentional outputs 309A, 309B, and 309C (or that similarity is above a threshold similarity), the attentional values from the first layer attentional outputs 309A, 309B, 309C, and 309D can be processed together by the second layer model instance 312A. In such fashion, implementations described herein can enable sequential attention layers for language-based attention mechanisms.

The first layer attentional outputs 309 can be processed with the second layer model instances 312 of the second model instance layer 310 to obtain second layer attentional outputs 313A – 313E. The second layer attentional outputs 313A – 313E can be generated in the same manner as that described with regards to the first layer attentional outputs 309. Here, the attentional value(s) can be processed by each of the second layer model instances 312 in the same manner as the portions 302 were processed using the first layer model instances 308. In other words, the role of the portions 302 as inputs to the first model instance layer 306 can be fulfilled by the attentional value inputs from the first layer attentional outputs 309 as inputs to the second model instance layer 310.

The second layer attentional outputs 313 can be processed with the third layer model instances 316 of the third model instance layer 314 to obtain third layer attentional outputs 318A – 318C (generally, third layer attentional outputs 318). Here, unlike the second model instance layer 310, the third model instance layer 314 can include fewer model instances than the immediately preceding model layer, and as such, can include fewer models than the number of attentional value outputs produced by the preceding layer. Thus, some (or all) of the third layer model instances 316 can merge attentional value outputs from the second layer attentional outputs 313.

The particular attentional value outputs being merged by each of the third layer model instances 316 can be determined in the same manner as described with regards to the first layer model instances 308 and the second layer model instances 312. To follow the depicted example, assume that attentional weights are calculated for the attentional value output of the second layer attentional outputs 313A. If the attentional weights indicate a similarity to the attentional value outputs from second layer attentional outputs 313B and 313C, the third layer model instance 316A can merge (e.g., generate an aggregate summary, etc.) the attentional value outputs from second layer attentional outputs 313A, 313B, and 313C to generate attentional value outputs 318A. For another example, assume that attentional weights calculated for the attentional value output of the second layer attentional outputs 313.

Additionally, or alternatively, in some implementations, a set of “splits” can be determined from the second layer attentional outputs 313. To follow the depicted example, attentional weights can be determined for each attentional value output of the second layer attentional outputs 313. The attentional weights determined for the second layer attentional outputs 313A can indicate a similarity between the second layer attentional outputs 313A, 313B, and 313C. The attentional weights determined for the second layer attentional outputs 313B can indicate a similarity between the second layer attentional outputs 313A and 313E. The attentional weights determined for the second layer attentional outputs 313C can indicate a similarity between the second layer attentional outputs 313A and 313B. However, the attentional weights determined for the second layer attentional outputs 313E can indicate a similarity to only the second layer attentional outputs 313D.

Here, as only three model instances are available in the third model instance layer 314, three combinations of attentional value outputs can be selected for processing with the three model instances. A “combination” of attentional value outputs can refer to a particular attentional value output and one or more other attentional value output(s) with a semantic similarity to the particular attentional value output that is above a threshold similarity These combinations can be selected based on the number and/or identity of attentional value outputs included in each combination, the number of available model instances in the successive layer, etc.

This process can be repeated for an output model instance 320 as described with regards to FIG. 2A. For example, assume that attentional weights for the third layer attentional outputs 318A indicate a semantic similarity above a threshold similarity with the third layer attentional outputs 318C, but not with the third layer attentional outputs 318B. Further assume that attentional weights for the third layer attentional outputs 318C indicate a semantic similarity above a threshold similarity with the third layer attentional outputs 318A, but not with the third layer attentional outputs 318B. Here, since the third layer attentional outputs 318B are not similar to any other third layer attentional outputs 318, the third layer attentional outputs 318B can be filtered from the inputs processed by the output model instance 320.

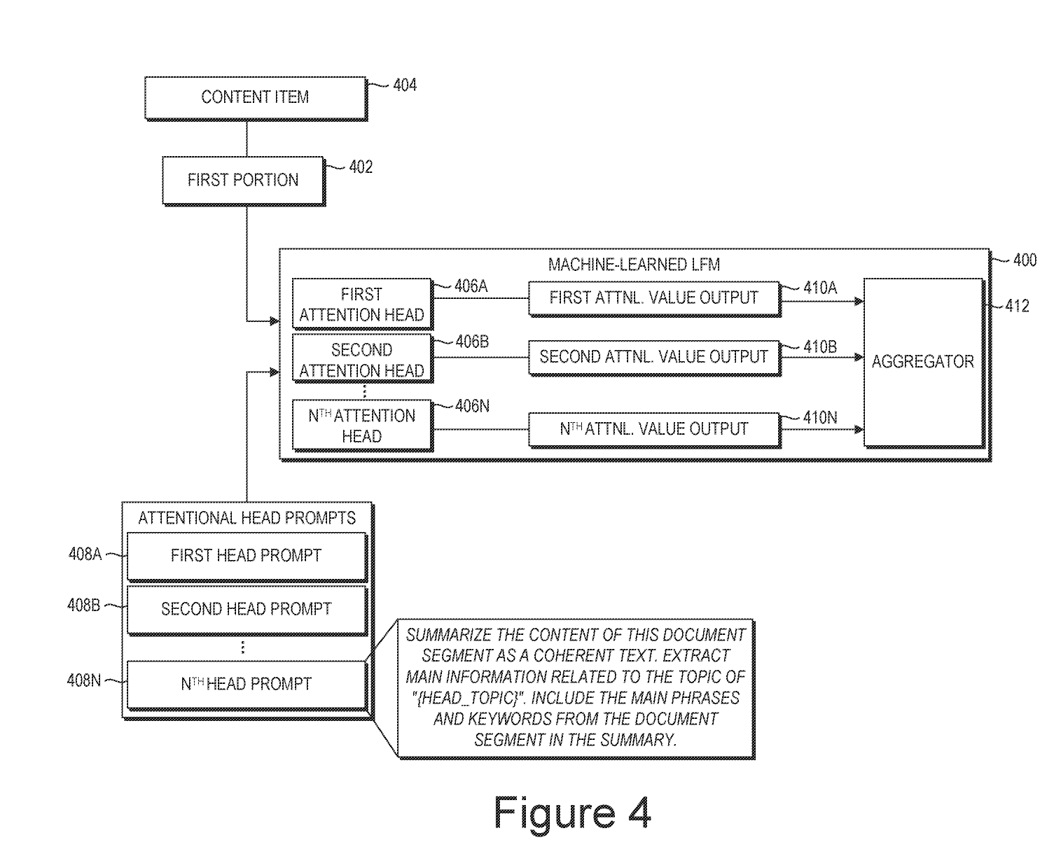

FIG. 4 is a block diagram of a machine-learned LFM with multiple attention heads according to some implementations of the present disclosure. In particular a machine-learned LFM 400 can process a first portion 402 of a content item 404. The machine-learned LFM 400 can include a plurality of attention heads 406A – 406N (generally, attention heads 406). Each of the attention heads 406 can represent an operation in which a machine-learned LFM (e.g., the machine-learned LFM 400, another instance of the machine-learned LFM 400, etc.) processes the first portion 402 and one of a plurality of attentional head prompts 408A – 408N (generally, attentional head prompts 408). Each of the attentional head prompts 408 can indicate a particular topic. The attentional head prompts 408 can further instruct the machine-learned LFM 400 (or one of the attention heads 406) to summarize the first portion 402 of the content item 404 while extracting information related to the topic described by the attentional head prompts 408. The attention heads 406 can process the first portion 402 alongside the attentional head prompts 408 to respectively obtain attentional value outputs 410A – 410N (generally, attentional value sub-outputs 410).

For example, assume that the content item 100 is a book about Roman history, and the first attentional head prompt 408A instructs the first attention head 406A to extract information related to Julius Caesar. The first attention head 406A can process the first portion 402 to obtain the first attentional value output 410A, which can include information related to Julius Caesar from the first portion 402.

In some implementations, each of the attentional heads 406 can represent an instance of the machine-learned LFM 400. Alternatively, in some implementations, each of the attention heads 406 can be a logical representation of an operation in which a portion of the content item 404 is processed alongside a corresponding prompt of the attentional head prompts 408 to generate an attentional value output 410. For example, assume that the machine-learned LFM 400 is a single instance of an LFM. The first attention head 406A can be or include instructions, such as a set of software instructions, script, etc., that when executed, causes the machine-learned LFM 400 to process the first portion 402 and the first head prompt 408A to generate the first attentional value output 410A. The second attention head 406B can be the same type of instructions that, when executed, cause the machine-learned LFM 400 to process the first portion 402 and the second attentional head prompt 408B to generate the second attentional value output 410B. In some implementations, the attention heads 406 can represent a mix of separately instanced models and logical operations. For example, six attention heads may represent operations that are performing using a set of machine-learned LFM instances less than six (with a quantity of models that can be adjusted dynamically based on system and/or request load).

The attentional value outputs 410 can be processed with an aggregator 412 to obtain an output 414. The aggregator 412 can aggregate the outputs of the attention heads 406 (e.g., the attentional value outputs 410) into one summary using a LFM. As such, the aggregator 412 can also represent a separately instanced machine-learned LFM or an operation performed using the machine-learned LFM 400. In some implementations, the number of attention heads can be limited based on the output token length of the attention head. If the output token length is represented as T, the context window length limit (C) can enforce that T x H < C. It should be noted that, although not illustrated, attentional key outputs and query outputs can be generated alongside the attentional value outputs 410. These key outputs and query outputs can be utilized in the same manner as described previously with regards to FIGS. 1A-3.

In some implementations, the attention heads 406 can be leveraged to perform certain tasks, such as long term extractive summarization (e.g., selection of document segments as the output for a summarization task, etc.). To do so, a two-step process can be performed. First, abstractive summarization of a long document can be performed by using the attentional head prompts which are directed to multiple topics. Here, the extractive summarization is performed in steps and each step correlates to a single layer of the machine-learned LFM 400 that prunes M portions of the content item 404. The output of the second phase can be a classification that identifies the least relevant segments to be extracted from extractive summarization.

It should be noted that implementations described herein are primarily discussed in the context of encoding an input (e.g., the first portion 402, the content item 404, etc.) for subsequent decoding to produce a generative output. However, implementations described herein also enable language-based attention mechanisms in the context of decoding. To do so, masked attention can be utilized by attending to document segments to the left of the segment at the current position similar to the decoder. Question answering is another task supported by implementations described herein. The question answering task can also be formed by modifying the attentional query prompt such that the query is conditioned on the question. To generate the answer, the decoder architecture is used to generate an answer with cross attention with a long-term context that includes all document parts (or different documents for the case of multi-doc QA).

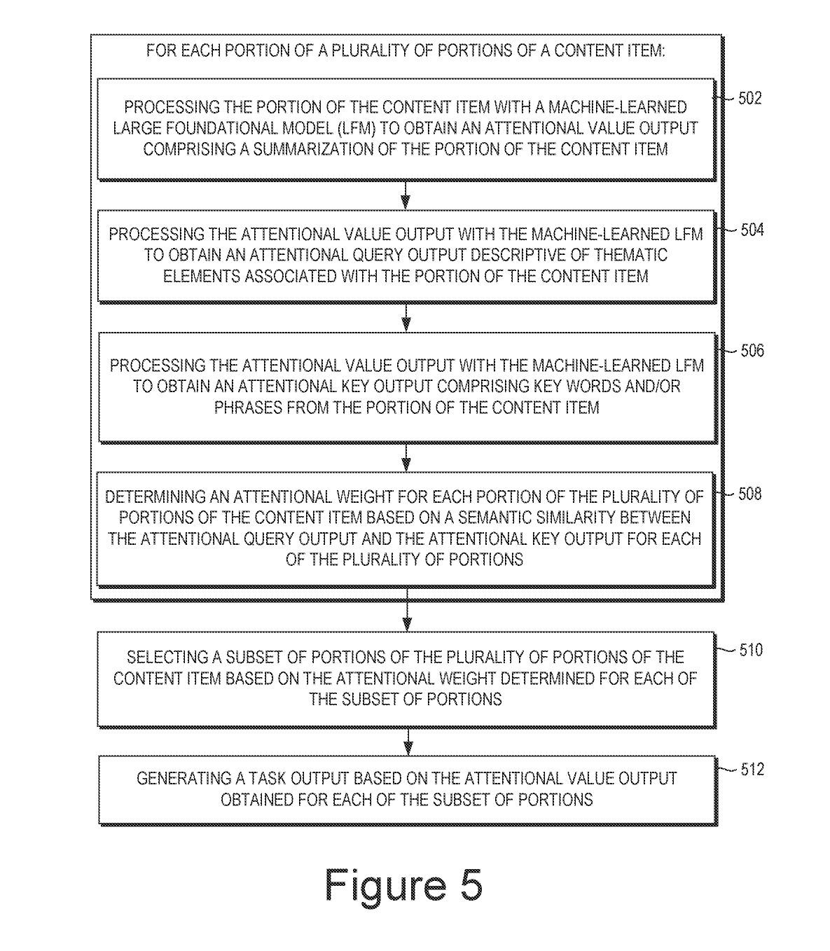

FIG. 5 is a flow diagram of an example method 500 for processing inputs with a language-based attention mechanism according to some implementations of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 502, a computing system can, for each portion of a plurality of portions of a content item, process the portion of the content item with a machine-learned LFM to obtain an attentional value output that includes a summarization of the portion of the content item. For example, the content item can include at least one of video content, image content, audio content, Mixed Reality (MR) content, or textual content. In some implementations, a quantity of instances of the machine-learned LFM included in the first model instance layer is equal to a quantity of instances of the machine-learned LFM included in the second model instance layer of the hierarchical processing structure.

In some implementations, processing the portion of the content item with the machine-learned LFM to obtain the attentional value output can include processing the portion of the content item and an attentional value prompt with the machine-learned LFM to obtain the attentional value output, wherein the attentional value prompt is descriptive of instructions to summarize the portion of the content item.

At 504, the computing system can, for each portion of the plurality of portions of the content item, process the attentional value output with the machine-learned LFM to obtain an attentional query output descriptive of thematic elements associated with the portion of the content item. In some implementations, processing the attentional value output with the machine-learned LFM to obtain the attentional query output can include processing the attentional value output with a first instance of the machine-learned LFM to obtain the attentional query output. Processing the attentional value output with the machine-learned LFM can include processing the attentional value output with a second instance of the machine-learned LFM to obtain the attentional key output. A first model instance layer of a plurality of model instance layers of a hierarchical processing structure can include the first instance and the second instance of the machine-learned LFM.

In some implementations, processing the attentional value output with the machine-learned LFM to obtain the attentional query output can include processing the summarization of the portion of the content item from the attentional value output and an attentional query prompt to obtain the attentional query output. The attentional query prompt can be descriptive of instructions to identify thematic elements associated with the portion of the content item from the portion of the content item.

At 506, the computing system can, for each portion of the plurality of portions of the content item, process the attentional value output with the machine-learned LFM to obtain an attentional key output comprising key words and/or phrases from the portion of the content item.

At 508, the computing system can determine an attentional weight for each portion of the plurality of portions of the content item based on a semantic similarity between the attentional query output and the attentional key output for each of the plurality of portions.

At 510, the computing system can select a subset of portions of the plurality of portions of the content item based on the attentional weight determined for each of the subset of portions.

At 512, the computing system can generate a task output based on the attentional value output obtained for each of the subset of portions. In some implementations, generating the task output based on the attentional value output obtained for each of the subset of portions can include, for each portion of the subset of portions of the content item, identifying one or more target instances of the machine-learned LFM from a second model instance layer of the hierarchical processing structure. The computing system can process at least the attentional value output obtained for the portion of the content item with at least one of the one or more target instances of the machine-learned LFM to obtain one or more respective second attentional value outputs.

In some implementations, identifying the one or more target instances of the machine-learned LFM from the second model instance layer of the hierarchical processing structure can include, based on the attentional weight for a first portion of the subset of portions, identifying a first target instance of the machine-learned LFM from a second model instance layer of the hierarchical processing structure for the attentional weight for the first portion of the subset of portions. Based on the attentional weight for a second portion of the subset of portions, a second target instance of the machine-learned LFM can be identified from the second model instance layer of the hierarchical processing structure for the attentional weight for the second portion of the subset of portions.

In some implementations, the first target instance and the second target instance of the machine-learned LFM can both include a same instance of the machine-learned LFM. Processing the attentional value output obtained for the portion of the content item with each of the one or more target instances of the machine-learned LFM to obtain the one or more respective second attentional value outputs can include merging the attentional value outputs for the first portion and the second portion of the subset of portions with the first target instance of the machine-learned LFM to obtain a merged attentional value output. The task output can be generated based at least in part on the merged attentional value output.

In some implementations, the first target instance and the second target instance of the machine-learned LFM both include different instances of the machine-learned LFM. Processing the attentional value output obtained for the portion of the content item with each of the one or more target instances of the machine-learned LFM to obtain the one or more respective second attentional value outputs can include processing the portion of the content item with a machine-learned LFM) to obtain an attentional value output comprising a summarization of the portion of the content item. The attentional value outputs can be merged for the first portion and the second portion of the subset of portions with the first target instance of the machine-learned LFM to obtain a merged attentional value output. The task output can be generated based at least in part on the third attentional value output.

In some implementations, processing the attentional value output with the machine-learned LFM to obtain the attentional key output can include processing the summarization of the portion of the content item from the attentional value output and an attentional key prompt to obtain the attentional key output. The attentional key prompt is descriptive of instructions to identify key words and/or phrases from the portion of the content item.

In some implementations, the content item can include video content. To process the portion of the content item with the machine-learned LFM to obtain the attentional value output, the computing system can process a portion of the video content with the machine-learned LFM to obtain the attentional value output including a summarization of one or more scenes depicted by the portion of the video content. Processing the attentional value output with the machine-learned LFM to obtain the attentional query output can include processing the attentional value output with the machine-learned LFM to obtain the attentional query output descriptive of thematic elements associated with the portion of the video content. Processing the attentional value output with the machine-learned LFM to obtain the attentional key output can include processing the attentional value output with the machine-learned LFM to obtain the attentional key output including key words and/or phrases spoken during the one or more scenes depicted by the portion of the video content.

In some implementations, the content item further comprises audio content synchronized with the video content, and wherein processing the portion of the video content with the machine-learned LFM to obtain the attentional value output can include processing the portion of the video content with a video encoder portion of the machine-learned LFM. The computing system can process a portion of the audio content synchronized with the portion of the video content with an audio encoder portion of the machine-learned LFM.

In some implementations, processing the portion of the content item with a machine-learned LFM to obtain the attentional value output comprising the summarization of the portion of the content item can include, for each topic of a plurality of topics, processing the portion of the content item and a prompt indicative of the topic of the plurality of topics to obtain an attentional value sub-output of a plurality of attentional value sub-outputs. The portion of the attentional value sub-output can summarize the portion of the content item based on the topic. The computing system can aggregate the attentional value sub-outputs obtained for each topic of the plurality of topics to obtain the attentional value output.

### Example Devices and Systems

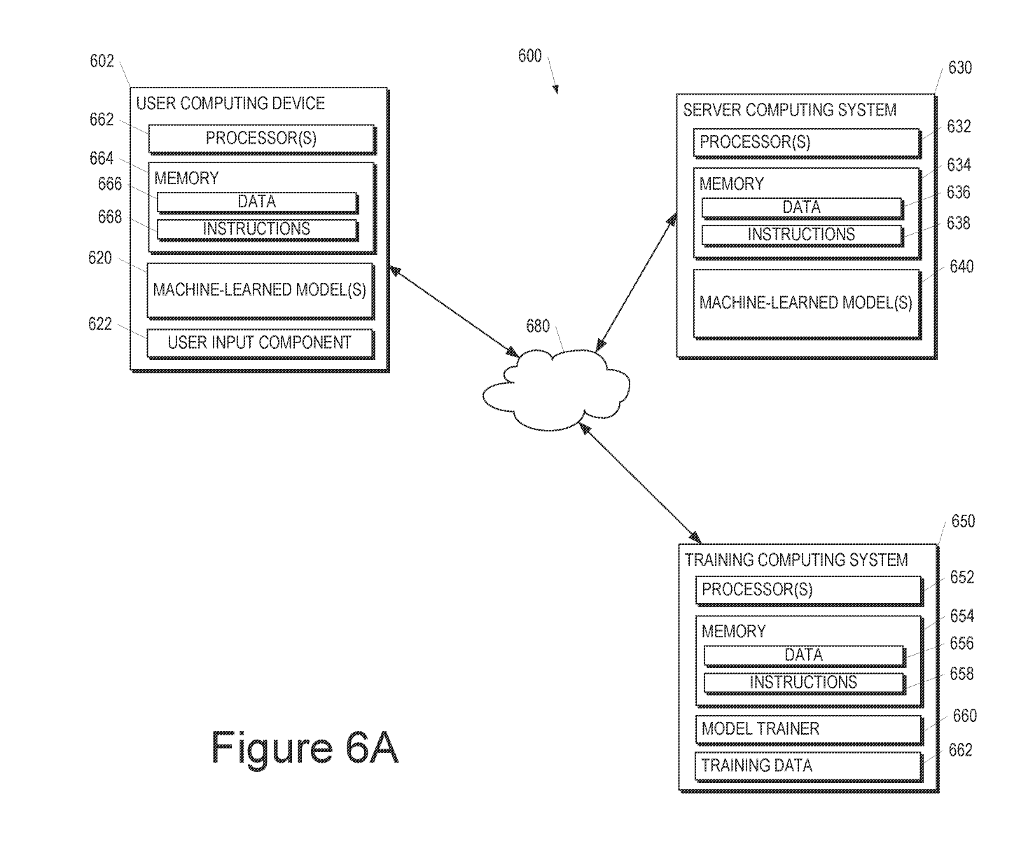

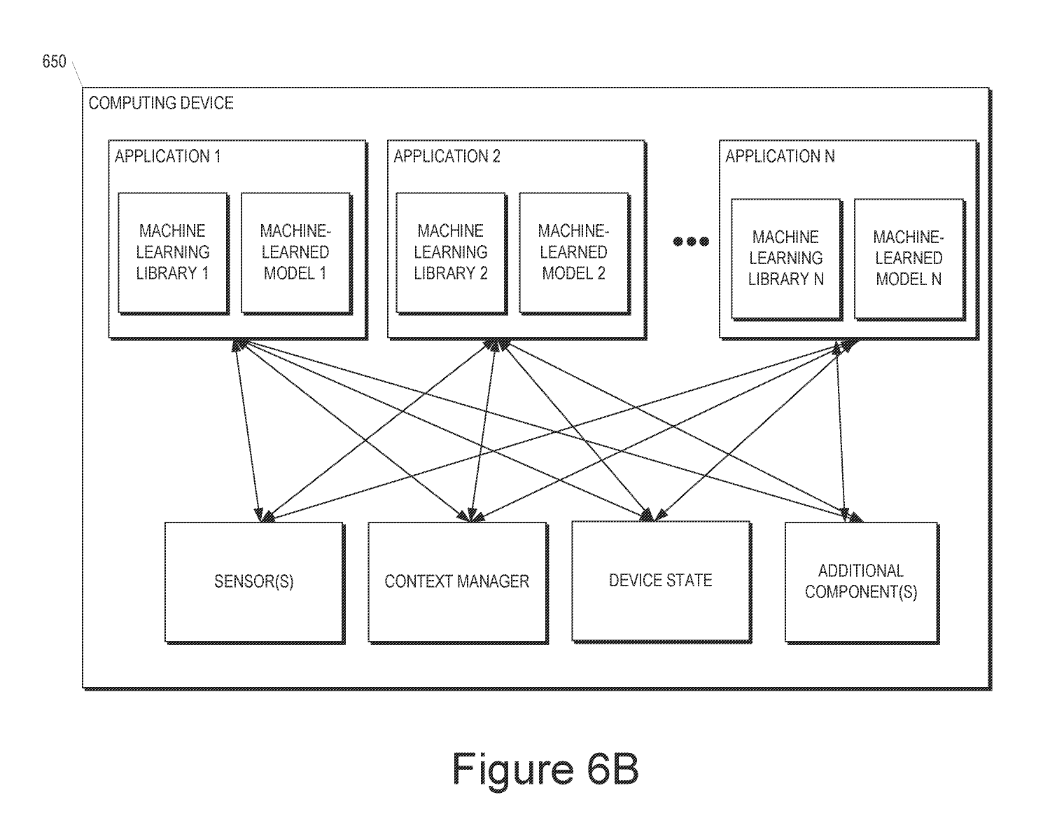

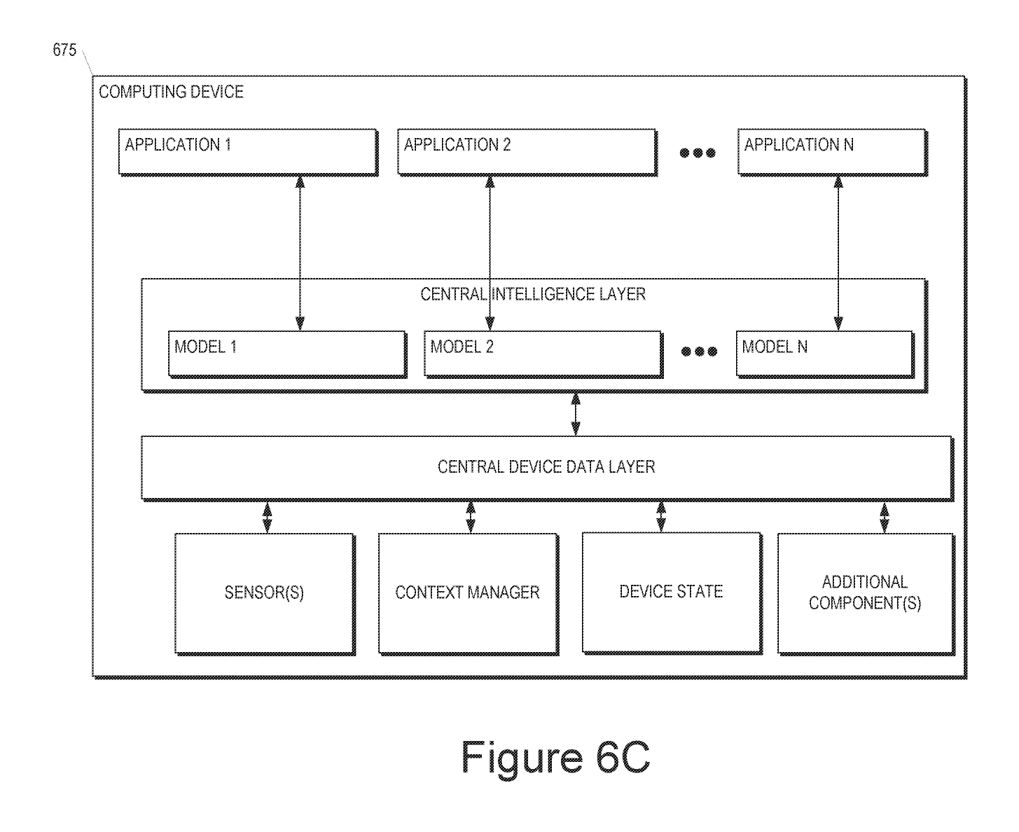

FIG. 6A depicts a block diagram of an example computing system 600 that performs generative tasks using language-based attention mechanisms according to some implementations of the present disclosure. The system 600 includes a user computing device 602, a server computing system 630, and a training computing system 650 that are communicatively coupled over a network 680.

The user computing device 602 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 602 includes one or more processors 612 and a memory 614. The one or more processors 612 can be any suitable processing device (e.g., a processor core, a microprocessor, an ASIC, an FPGA, a controller, a microcontroller, etc.) and can be one processor or a plurality of processors that are operatively connected. The memory 614 can include one or more non-transitory computer-readable storage media, such as RAM, ROM, EEPROM, EPROM, flash memory devices, magnetic disks, etc., and combinations thereof. The memory 614 can store data 616 and instructions 618 which are executed by the processor 612 to cause the user computing device 602 to perform operations.

In some implementations, the user computing device 602 can store or include one or more machine-learned models 620 (e.g., the machine-learned LFM 104 of FIG. 1A, the model instances 105 of FIG. 2A, etc.). For example, the machine-learned models 620 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 620 are discussed with reference to FIGS. 1-5.

In some implementations, the one or more machine-learned models 620 can be received from the server computing system 630 over network 680, stored in the user computing device memory 614, and then used or otherwise implemented by the one or more processors 612. In some implementations, the user computing device 602 can implement multiple parallel instances of a single machine-learned model 620.

Additionally or alternatively, one or more machine-learned models 640 can be included in or otherwise stored and implemented by the server computing system 630 that communicates with the user computing device 602 according to a client-server relationship (e.g., the machine-learned LFM 104 of FIG. 1A, the model instances 105 of FIG. 2A, etc.). For example, the machine-learned models 640 can be implemented by the server computing system 640 as a portion of a web service (e.g., a generative AI/ML service). Thus, one or more models 620 can be stored and implemented at the user computing device 602 and/or one or more models 640 can be stored and implemented at the server computing system 630.

The user computing device 602 can also include one or more user input components 622 that receives user input. For example, the user input component 622 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 630 includes one or more processors 632 and a memory 634. The one or more processors 632 can be any suitable processing device (e.g., a processor core, a microprocessor, an ASIC, an FPGA, a controller, a microcontroller, etc.) and can be one processor or a plurality of processors that are operatively connected. The memory 634 can include one or more non-transitory computer-readable storage media, such as RAM, ROM, EEPROM, EPROM, flash memory devices, magnetic disks, etc., and combinations thereof. The memory 634 can store data 636 and instructions 638 which are executed by the processor 632 to cause the server computing system 630 to perform operations.

In some implementations, the server computing system 630 includes or is otherwise implemented by one or more server computing devices. In instances in which the server computing system 630 includes plural server computing devices, such server computing devices can operate according to sequential computing architectures, parallel computing architectures, or some combination thereof.

As described above, the server computing system 630 can store or otherwise include one or more machine-learned models 640. For example, the models 640 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 640 are discussed with reference to FIGS. 1-5.

The user computing device 602 and/or the server computing system 630 can train the models 620 and/or 640 via interaction with the training computing system 650 that is communicatively coupled over the network 680. The training computing system 650 can be separate from the server computing system 630 or can be a portion of the server computing system 630.

The training computing system 650 includes one or more processors 652 and a memory 654. The one or more processors 652 can be any suitable processing device (e.g., a processor core, a microprocessor, an ASIC, an FPGA, a controller, a microcontroller, etc.) and can be one processor or a plurality of processors that are operatively connected. The memory 654 can include one or more non-transitory computer-readable storage media, such as RAM, ROM, EEPROM, EPROM, flash memory devices, magnetic disks, etc., and combinations thereof. The memory 654 can store data 656 and instructions 658 which are executed by the processor 652 to cause the training computing system 650 to perform operations. In some implementations, the training computing system 650 includes or is otherwise implemented by one or more server computing devices.

The training computing system 650 can include a model trainer 660 that trains the machine-learned models 620 and/or 640 stored at the user computing device 602 and/or the server computing system 630 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 660 can perform a number of generalization techniques (e.g., weight decays, dropouts, etc.) to improve the generalization capability of the models being trained. In particular, the model trainer 660 can train the models 620 and/or 640 based on a set of training data 662.

In some implementations, if the user has provided consent, the training examples can be provided by the user computing device 602. Thus, in such implementations, the model 620 provided to the user computing device 602 can be trained by the training computing system 650 on user-specific data received from the user computing device 602. In some instances, this process can be referred to as personalizing the model.

The model trainer 660 includes computer logic utilized to provide desired functionality. The model trainer 660 can be implemented in hardware, firmware, and/or software controlling a general purpose processor. For example, in some implementations, the model trainer 660 includes program files stored on a storage device, loaded into a memory and executed by one or more processors. In other implementations, the model trainer 660 includes one or more sets of computer-executable instructions that are stored in a tangible computer-readable storage medium such as RAM, hard disk, or optical or magnetic media.

The network 680 can be any type of communications network, such as a local area network (e.g., intranet), wide area network (e.g., Internet), or some combination thereof and can include any number of wired or wireless links. In general, communication over the network 680 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 6A illustrates one example computing system that can be used to implement the present disclosure. Other computing systems can be used as well. For example, in some implementations, the user computing device 602 can include the model trainer 660 and the training dataset 662. In such implementations, the models 620 can be both trained and used locally at the user computing device 602. In some of such implementations, the user computing device 602 can implement the model trainer 660 to personalize the models 620 based on user-specific data.

FIG. 6B depicts a block diagram of an example computing device 650 that performs model training according to some implementations of the present disclosure. The computing device 650 can be a user computing device or a server computing device.

The computing device 650 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 6B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 6C depicts a block diagram of an example computing device 675 that performs generative tasks using language-based attention mechanisms according to some implementations of the present disclosure. The computing device 675 can be a user computing device or a server computing device.

The computing device 675 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 6C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 675.

The central intelligence layer can communicate with a central device data layer. The central device data layer can be a centralized repository of data for the computing device 675. As illustrated in FIG. 6C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method, comprising:
for each portion of a plurality of portions of a content item:
processing, by a computing system comprising one or more processing devices, the portion of the content item with a machine-learned Large Foundational Model (LFM) to obtain an attentional value output comprising a summarization of the portion of the content item;
processing, by the computing system, the attentional value output with the machine-learned LFM to obtain an attentional query output descriptive of thematic elements associated with the portion of the content item; and
processing, by the computing system, the attentional value output with the machine-learned LFM to obtain an attentional key output comprising key words and/or phrases from the portion of the content item;
determining, by the computing system, an attentional weight for each portion of the plurality of portions of the content item based on a semantic similarity between the attentional query output and the attentional key output for each of the plurality of portions;
selecting, by the computing system, a subset of portions of the plurality of portions of the content item based on the attentional weight determined for each of the subset of portions; and
generating, by the computing system, a task output based on the attentional value output obtained for each of the subset of portions.

2. The computer-implemented method of claim 1, wherein processing the attentional value output with the machine-learned LFM to obtain the attentional query output comprises:
processing, by the computing system, the attentional value output with a first instance of the machine-learned LFM to obtain the attentional query output;
wherein processing the attentional value output with the machine-learned LFM comprises:
processing, by the computing system, the attentional value output with a second instance of the machine-learned LFM to obtain the attentional key output; and
wherein a first model instance layer of a plurality of model instance layers of a hierarchical processing structure comprises the first instance and the second instance of the machine-learned LFM.

3. The computer-implemented method of claim 2, wherein a quantity of instances of the machine-learned LFM included in the first model instance layer is equal to a quantity of instances of the machine-learned LFM included in the second model instance layer of the hierarchical processing structure.

4. The computer-implemented method of claim 2, wherein generating the task output based on the attentional value output obtained for each of the subset of portions comprises:
for each portion of the subset of portions of the content item:
identifying, by the computing system, one or more target instances of the machine-learned LFM from a second model instance layer of the hierarchical processing structure; and
processing, by the computing system, at least the attentional value output obtained for the portion of the content item with at least one of the one or more target instances of the machine-learned LFM to obtain one or more respective second attentional value outputs.

5. The computer-implemented method of claim 4, wherein identifying the one or more target instances of the machine-learned LFM from the second model instance layer of the hierarchical processing structure comprises:
based on the attentional weight for a first portion of the subset of portions, identifying, by the computing system, a first target instance of the machine-learned LFM from a second model instance layer of the hierarchical processing structure for the attentional weight for the first portion of the subset of portions; and
based on the attentional weight for a second portion of the subset of portions, identifying, by the computing system, a second target instance of the machine-learned LFM from the second model instance layer of the hierarchical processing structure for the attentional weight for the second portion of the subset of portions.

6. The computing system of claim 5, wherein the first target instance and the second target instance of the machine-learned LFM both comprise a same instance of the machine-learned LFM, and wherein processing the attentional value output obtained for the portion of the content item with each of the one or more target instances of the machine-learned LFM to obtain the one or more respective second attentional value outputs comprises:
merging, by the computing system, the attentional value outputs for the first portion and the second portion of the subset of portions with the first target instance of the machine-learned LFM to obtain a merged attentional value output; and
wherein the task output is generated based at least in part on the merged attentional value output.

7. The computing system of claim 5, wherein the first target instance and the second target instance of the machine-learned LFM both comprise different instances of the machine-learned LFM, and wherein processing the attentional value output obtained for the portion of the content item with each of the one or more target instances of the machine-learned LFM to obtain the one or more respective second attentional value outputs comprises:
processing, by the computing system, the portion of the content item with a machine-learned LFM) to obtain an attentional value output comprising a summarization of the portion of the content item
merging, by the computing system, the attentional value outputs for the first portion and the second portion of the subset of portions with the first target instance of the machine-learned LFM to obtain a merged attentional value output; and
wherein the task output is generated based at least in part on the third attentional value output.

8. The computer-implemented method of claim 1, wherein processing the attentional value output with the machine-learned LFM to obtain the attentional key output comprises:
processing, by the computing system, the summarization of the portion of the content item from the attentional value output and an attentional key prompt to obtain the attentional key output, wherein the attentional key prompt is descriptive of instructions to identify key words and/or phrases from the portion of the content item.

9. The computer-implemented method of claim 1, wherein processing the attentional value output with the machine-learned LFM to obtain the attentional query output comprises:
processing, by the computing system, the summarization of the portion of the content item from the attentional value output and an attentional query prompt to obtain the attentional query output, wherein the attentional query prompt is descriptive of instructions to identify thematic elements associated with the portion of the content item from the portion of the content item.

10. The computer-implemented method of claim 1, wherein processing the portion of the content item with the machine-learned LFM to obtain the attentional value output comprises:
processing, by the computing system, the portion of the content item and an attentional value prompt with the machine-learned LFM to obtain the attentional value output, wherein the attentional value prompt is descriptive of instructions to summarize the portion of the content item.

11. The computer-implemented method of claim 1, wherein the content item comprises at least one of:
video content;
image content;
audio content;
Mixed Reality (MR) content; or
textual content.

12. The computer-implemented method of claim 11, wherein the content item comprises video content;
wherein processing the portion of the content item with the machine-learned LFM to obtain the attentional value output comprises processing, by the computing system, a portion of the video content with the machine-learned LFM to obtain the attentional value output comprising a summarization of one or more scenes depicted by the portion of the video content;
wherein processing the attentional value output with the machine-learned LFM to obtain the attentional query output comprises processing, by the computing system, the attentional value output with the machine-learned LFM to obtain the attentional query output descriptive of thematic elements associated with the portion of the video content; and
wherein processing the attentional value output with the machine-learned LFM to obtain the attentional key output comprises processing, by the computing system, the attentional value output with the machine-learned LFM to obtain the attentional key output comprising key words and/or phrases spoken during the one or more scenes depicted by the portion of the video content.

13. The computer-implemented method of claim 11, wherein the content item further comprises audio content synchronized with the video content, and wherein processing the portion of the video content with the machine-learned LFM to obtain the attentional value output comprises:
processing, by the computing system, the portion of the video content with a video encoder portion of the machine-learned LFM; and
processing, by the computing system, a portion of the audio content synchronized with the portion of the video content with an audio encoder portion of the machine-learned LFM.

14. The computer-implemented method of claim 1, wherein processing the portion of the content item with a machine-learned LFM to obtain the attentional value output comprising the summarization of the portion of the content item comprises:
for each topic of a plurality of topics:
processing, by the computing system, the portion of the content item and a prompt indicative of the topic of the plurality of topics to obtain an attentional value sub-output of a plurality of attentional value sub-outputs, wherein the portion of the attentional value sub-output summarizes the portion of the content item based on the topic; and
aggregating, by the computing system, the attentional value sub-outputs obtained for each topic of the plurality of topics to obtain the attentional value output.

15. A computing system, comprising:
one or more processor devices;
one or more non-transitory computer-readable media that store instructions that, when executed by the one or more processors, cause the computing system to perform operations, the operations comprising:
for each portion of a plurality of portions of a content item:
processing the portion of the content item with a machine-learned Large Foundational Model (LFM) to obtain an attentional value output comprising a summarization of the portion of the content item;
processing the attentional value output with the machine-learned LFM to obtain an attentional query output descriptive of thematic elements associated with the portion of the content item; and
processing the attentional value output with the machine-learned LFM to obtain an attentional key output comprising key words and/or phrases from the portion of the content item;
determining an attentional weight for each portion of the plurality of portions of the content item based on a semantic similarity between the attentional query output and the attentional key output for each of the plurality of portions;
selecting a subset of portions of the plurality of portions of the content item based on the attentional weight determined for each of the subset of portions; and
generating a task output based on the attentional value output obtained for each of the subset of portions.

16. The computing system of claim 15, wherein processing the attentional value output with the machine-learned LFM to obtain the attentional query output comprises:
processing the attentional value output with a first instance of the machine-learned LFM to obtain the attentional query output;
wherein processing the attentional value output with the machine-learned LFM comprises:
processing the attentional value output with a second instance of the machine-learned LFM to obtain the attentional key output; and
wherein a first model instance layer of a plurality of model instance layers of a hierarchical processing structure comprises the first instance and the second instance of the machine-learned LFM.

17. The computing system of claim 16, wherein a quantity of instances of the machine-learned LFM included in the first model instance layer is equal to a quantity of instances of the machine-learned LFM included in the second model instance layer of the hierarchical processing structure.

18. The computing system of claim 16, wherein generating the task output based on the attentional value output obtained for each of the subset of portions comprises:
for each portion of the subset of portions of the content item:
identifying one or more target instances of the machine-learned LFM from a second model instance layer of the hierarchical processing structure; and
processing at least the attentional value output obtained for the portion of the content item with at least one of the one or more target instances of the machine-learned LFM to obtain one or more respective second attentional value outputs.

19. The computing system of claim 18, wherein identifying the one or more target instances of the machine-learned LFM from the second model instance layer of the hierarchical processing structure comprises:
based on the attentional weight for a first portion of the subset of portions, identifying a first target instance of the machine-learned LFM from a second model instance layer of the hierarchical processing structure for the attentional weight for the first portion of the subset of portions; and
based on the attentional weight for a second portion of the subset of portions, identifying a second target instance of the machine-learned LFM from the second model instance layer of the hierarchical processing structure for the attentional weight for the second portion of the subset of portions.

20. One or more non-transitory computer-readable media that store instructions that, when executed by one or more processor devices, cause the one or more processor devices to perform operations, the operations comprising:
for each portion of a plurality of portions of a content item:
processing the portion of the content item with a machine-learned Large Foundational Model (LFM) to obtain an attentional value output comprising a summarization of the portion of the content item;
processing the attentional value output with the machine-learned LFM to obtain an attentional query output descriptive of thematic elements associated with the portion of the content item; and
processing the attentional value output with the machine-learned LFM to obtain an attentional key output comprising key words and/or phrases from the portion of the content item;
determining an attentional weight for each portion of the plurality of portions of the content item based on a semantic similarity between the attentional query output and the attentional key output for each of the plurality of portions;
selecting a subset of portions of the plurality of portions of the content item based on the attentional weight determined for each of the subset of portions; and
generating a task output based on the attentional value output obtained for each of the subset of portions.
